(19) United States
(12) Patent Application Publication
(10) Pub. No.: US 2014/0176339 A1
(43) Pub. Date: Jun. 26, 2014

(54) DEVICE FOR MONITORING POWER CONSUMPTION

(71) Applicant: NETVOX TECHNOLOGY CO., LTD, Tainan City (TW)

(72) Inventor: Shiu-Cheng Shen, Tainan City (TW)

(73) Assignee: NETVOX TECHNOLOGY CO., LTD, Tainan City (TW)

(21) Appl. No.: 14/132,242

(22) Filed: Dec. 18, 2013

(30) Foreign Application Priority Data
Dec. 21, 2012 (TW) 101149079

(51) Int. Cl. G01D 4/00

(52) U.S. Cl. CPC G01D 4/002
USPC 340/870.02

(57) ABSTRACT

A device for monitoring power consumption includes a measuring unit, a wireless communication unit, and a shell unit. The measuring unit is for obtaining a set of current parameters of an electricity-consuming apparatus, and is operable to obtain power consumption information with reference to the set of current parameters. The wireless communication unit is operable to transmit the power consumption information. The shell unit includes a shell body and a set of connection ports. The shell body is formed with at least one opening. The set of connection ports is disposed at the at least one opening. The set of current measuring components is coupled to a processor via the set of connection ports, and is exposed from the shell body.

### CROSS-REFERENCE TO RELATED APPLICATION

This application claims priority of Taiwanese Application No. 101149079, filed on Dec. 21, 2012.

### BACKGROUND OF THE INVENTION

1. Field of the Invention

The invention relates to a device for monitoring power consumption associated with an electricity-consuming apparatus.

2. Description of the Related Art

In response to the rising awareness about importance of energy saving and reduction of carbon emissions, some products, which are aimed to enable users of electrical appliances to monitor the power consumption of the electrical appliances, have been proposed. One such product may be an electrical meter to be mounted on an electrical component (such as power plugs and sockets, a power switch or a power distribution box) for obtaining the power consumption associated with the electrical component.

However, in cases where multiple electrical components are to be monitored, a plurality of electrical meters must be correspondingly employed, inevitably using up excessive space and requiring more power to operate. In addition, it may be beneficial to design the electrical meters such that the electrical meters may be mounted on the electrical components with relative ease.

### SUMMARY OF THE INVENTION

Therefore, the object of the present invention is to provide a device that is able to monitor power consumption of a plurality of electrical components simultaneously, and that has wireless transmission functionality.

Accordingly, a device of the present invention is for monitoring power consumption. The device is to be coupled to an electricity-consuming apparatus and comprises a measuring unit, a wireless communication unit, and a shell unit.

The measuring unit includes a set of current measuring components and a processor. The set of current measuring components is to be coupled to the electricity-consuming apparatus for obtaining a set of current parameters of the electricity-consuming apparatus. The processor is coupled to the set of current measuring components and is operable to obtain power consumption information with reference to the set of current parameters obtained by the set of current measuring components.

The wireless communication unit is coupled to the processor and is operable to transmit the power consumption information.

The shell unit includes a shell body and a set of connection ports. The shell body is disposed to receive the processor therein, and is formed with at least one opening. The set of connection ports is disposed at the at least one opening and is coupled to the processor.

The set of current measuring components is coupled to the processor via the set of connection ports, and is exposed from the shell body.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram of a preferred embodiment of a device for monitoring power consumption, according to the invention;

FIG. 2 is a perspective view of the device of the preferred embodiment that is to be coupled to an electricity-consuming apparatus;

FIG. 3 is a fragmentary exploded view of the device of the preferred embodiment;

FIG. 4 is a fragmentary assembled view of the device of the preferred embodiment;

FIG. 5 is a sectional view of the device of the preferred embodiment, illustrating the device being engaged with a slide track of the electricity-consuming apparatus;

FIG. 6 illustrates a track-engaging component of the device of the preferred embodiment in a locking position;

FIG. 7 illustrates the track-engaging component in an unlocking position;

FIG. 8 illustrates the device of the preferred embodiment coupled to a plurality of switches in a state of use; and

FIG. 9 illustrates a current measuring component of the device of the preferred embodiment being coupled to an electrical wire.

### DETAILED DESCRIPTION OF THE PREFERRED EMBODIMENT

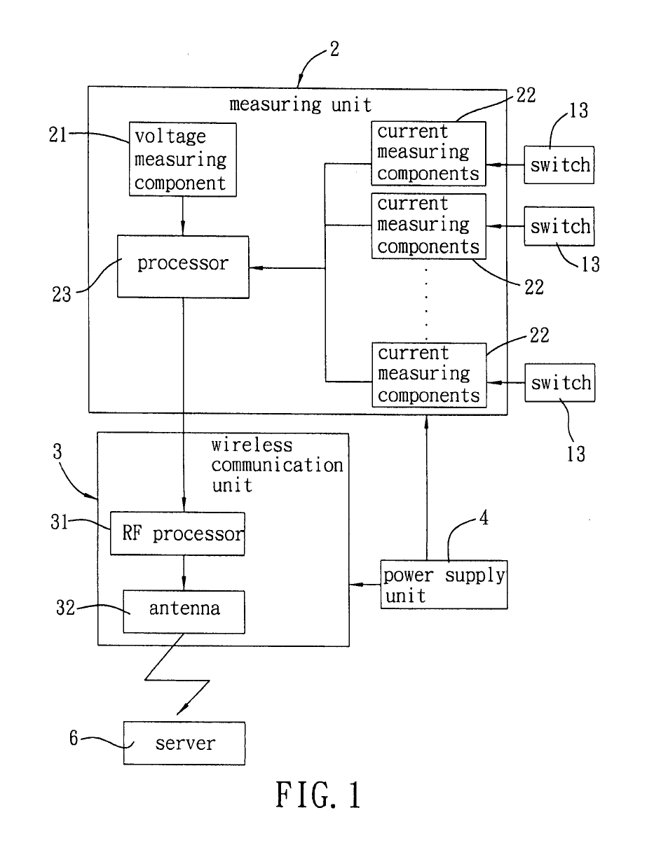

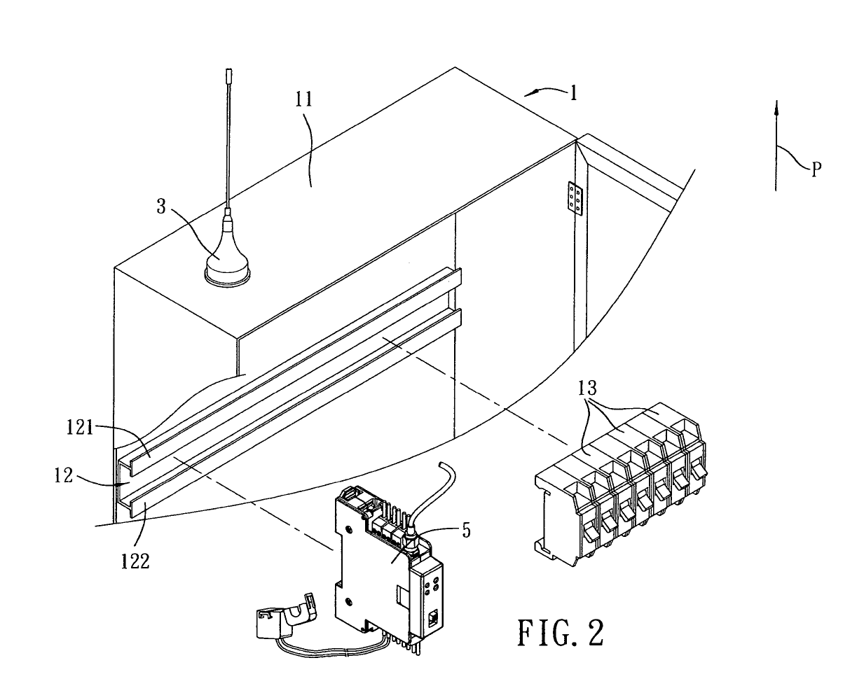

FIG. 1 illustrates the preferred embodiment of a device 100 for monitoring power consumption according to the present invention. As shown in FIG. 2, the device 100 is to be coupled to an electricity-consuming apparatus 1. The electricity-consuming apparatus 1 includes a housing 11, a slide track 12 disposed in the housing 11, and a set of parallel coupled switches 13 that is mounted on the slide track 12.

In this embodiment, the electricity-consuming apparatus 1 is a power distribution box that provides alternating current (AC) power, and the set of switches 13 includes seven switches 13. Power consumption associated with each of the switches 13 may be obtained using the device 100 of the present invention. In other embodiments, the electricity-consuming apparatus 1 may be embodied as various electrical devices or electronic devices that consume power, and may include any number of switches. Each of the switches 13 may be embodied as one of a no fuse breaker (NBF), a magnetic contactor (MC), and a relay. In some embodiments, the switches 13 may be embodied as electrical components whose current parameters can be measured.

Referring again to FIG. 1, the slide track 12 has a first track wall 121 and a second track wall 122 that are spaced apart from each other.

As best shown in FIGS. 1 to 3, the device 100 in this embodiment comprises a measuring unit 2, a wireless communication unit 3, a power supply unit 4, a shell unit 5, and a server 6.

The measuring unit 2 includes a voltage measuring component 21, a set of current measuring components 22, and a processor 23 coupled to the voltage measuring component 21 and the set of current measuring components 22.

In this embodiment, the voltage measuring component 21 is to obtain a voltage parameter of the electricity-consuming apparatus 1, and may be embodied as a chip implemented with voltage measuring functionality. Since the switches 13 of the electricity-consuming apparatus 1 are coupled in parallel, voltages across the switches 13 are identical, such that only one voltage measuring component 21 is required.

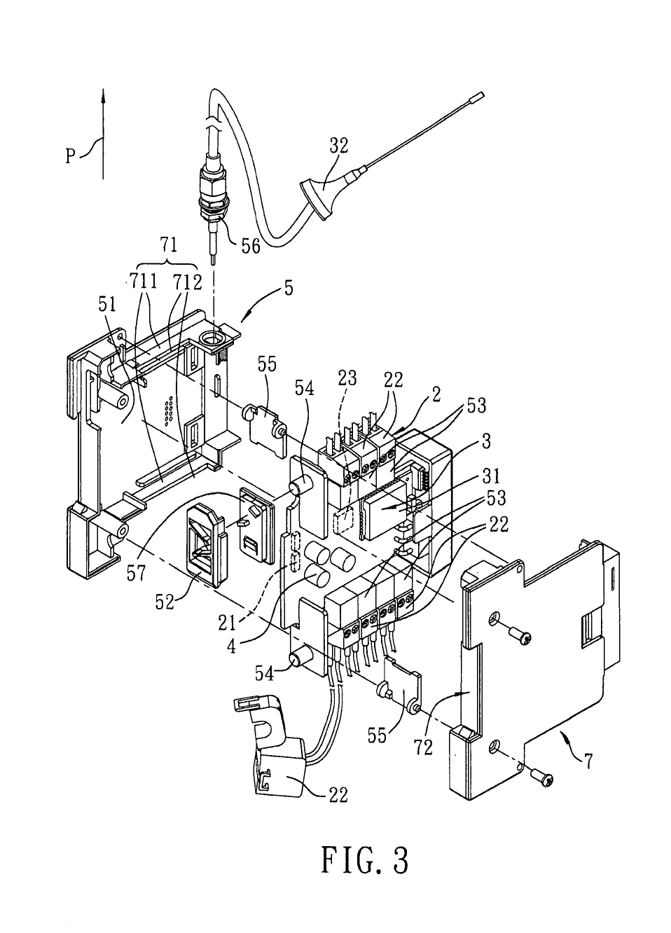

The set of current measuring components 22 is for obtaining a set of current parameters of the electricity-consuming apparatus 1, and may include a set of current clamps (see FIG. 3) that is for clamping to the switches 13.

The processor 23 is operable to obtain power consumption information with reference to the voltage parameter and the set of current parameters obtained by the voltage measuring component 21 and the set of current measuring components 22, respectively. The power consumption information includes the power consumption (in Watts) associated with each of the switches 13.

The wireless communication unit 3 is operable to transmit the power consumption information, and includes a radio frequency (RF) processor 31 and an antenna 32. The RF processor 31 is coupled to the processor 23. The antenna 32 is coupled to the RF processor 31 for allowing transmission of the power consumption information with a larger signal strength. Preferably, the antenna 32 is exposed from the housing 11, which may be considered an obstruction to wireless transmission.

The power supply unit 4 is coupled to the measuring unit 2 and the wireless communication unit 3 for providing power thereto. The power supply unit 4 may be a rectifier that receives the AC power from the electricity-consuming apparatus 1, and outputs direct current (DC) power to the measuring unit 2 and the wireless communication unit 3.

Referring to FIGS. 3 to 6, the shell unit 5 includes a shell body 7, a track-engaging component 52, a set of connection ports 53, a pair of conductor components 54, a pair of isolating tabs 55, and a communication port 56.

In this embodiment, the shell body 7 is assembled using two shell pieces and an assembling board 57. The assembled shell body 7 includes a main portion 71 and an assembly portion 72. The main portion 71 has two connecting walls 711 that are spaced apart from each other along a predetermined direction (P). Each of the connecting walls 711 is formed with an opening 712. The shell body 7 defines a receiving space 51, and is disposed to receive the voltage measuring component 21, the processor 23, the RF processor 31 and the power supply unit 4 in the receiving space 51.

The track-engaging component 52 is configured to couple the shell body 7 to the slide track 12, and is movable relative to the shell body 7 along the predetermined direction (P).

In this embodiment, the set of connection ports 53 includes seven connection ports 53 coupled to the processor 23. Each of the connection ports 53 is disposed at one of the openings 712.

Each of the conductor components 54 is disposed on the shell body 7 adjacent to a respective one of the openings 712, is electrically connected to the voltage measuring component 21 and the power supply unit 4, and is to be coupled to the electricity-consuming apparatus 1. Each of the isolating tabs 55 is disposed on the shell body 7, and is configured to provide isolation between a respective one of the conductor components 54 and the set of current measuring components 22. In this embodiment, the isolating tabs 55 are pivoted to the shell body 7.

The communication port 56 is disposed on the shell body 7, and is coupled to the RF processor 31 and the antenna.

In this embodiment, the assembly portion 72 includes a base wall 721, a pair of spaced-apart outer assembly walls 722, a first limiting block 723, a second limiting block 724, a third limiting block 725, and a pair of protruding blocks 726.

The base wall 721 is disposed adjacent to the slide track 12. The assembling board 57 is superposed on a part of the base wall 721. The outer assembly walls 722 protrude from the base wall 721 toward the slide track 12, and extend along the predetermined direction (P).

The first limiting block 723, the second limiting block 724 and the third limiting block 725 protrude from the base wall 721 toward the slide track 12, are disposed between the outer assembly walls 722, and are spaced apart from each other in the predetermined direction (P). In this embodiment, the first limiting block 723, the second limiting block 724 and the third limiting block 725 protrude from the assembling board 57.

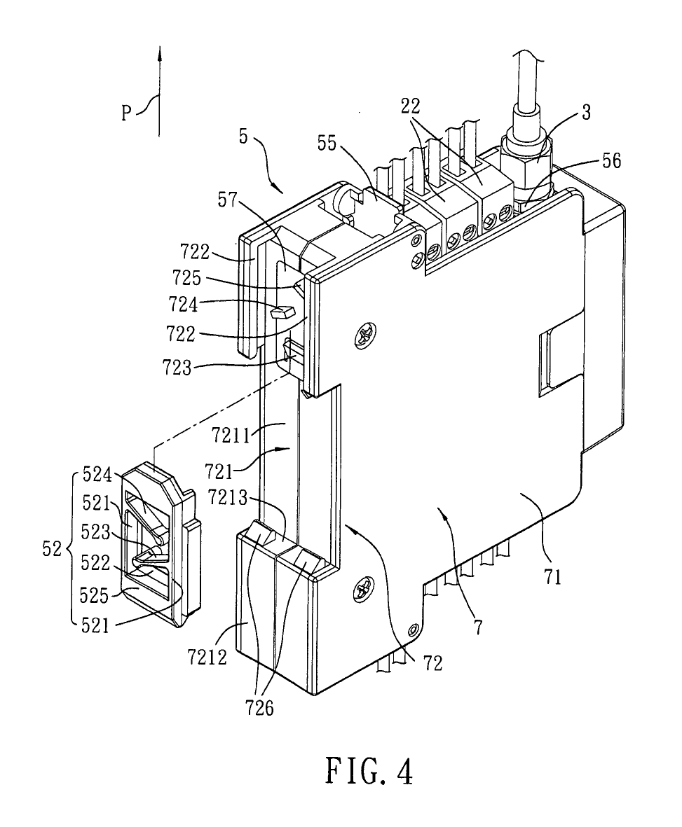

The base wall 721 has a stepped configuration (see FIG. 4), and has a first surface 7211 on which the assembling board 57 is superposed, a second surface 7212 that is parallel to the first surface 7211, and a third surface 7213 that extends between the first surface 7211 and the second surface 7212.

The first surface 7211 extends in the predetermined direction (P). The second surface 7212 is configured to protrude toward the slide track 12 relative to the first surface 7211. The protruding blocks 726 are disposed on the third surface 7213 and project toward the first limiting block 723.

The track-engaging component 52 is fitted between the outer assembly walls 722, and includes a pair of spaced-apart inner assembly walls 521, a limiting wall 522, a first resilient tab 523, a second resilient tab 524, and a space-defining wall 525.

Each of the inner assembly walls 521 is disposed to face a respective one of the outer assembly walls 722.

The limiting wall 522 interconnects the inner assembly walls 521, and is disposed between the first limiting block 723 and the second limiting block 724.

The first resilient tab 523 extends from a right one of the inner assembly walls 521 toward a left one of the inner assembly walls 521, is disposed between the limiting wall 522 and the second limiting block 724, and abuts against the second limiting block 724.

The second resilient tab 524 extend from the left one of the inner assembly walls 521 toward the right one of the inner assembly walls 521, is disposed between the second limiting block 724 and the third limiting block 725, and abuts against the third limiting block 725.

The space-defining wall 525 is spaced apart from the base wall 721, and cooperates with the base wall 721 to define a first track-receiving space 526 configured for sliding engagement with the first track wall 121 of the slide track 12. The protruding blocks 726 are spaced apart from the base wall 712, and cooperate with the base wall 721 to define a second track-receiving space 727 configured for sliding engagement with the second track wall 122 of the slide track 12.

In this embodiment, the set of current measuring components 22 is coupled to the processor 23 via the set of connection ports 53. Since each connection port 53 in the set is disposed at one of the openings 712, the set of current measuring components 22 is exposed from the shell body 7.

The conductor components 54 may be embodied as screws made of a conductive material, and are able to threadedly engage the assembly portion 72 for fixing electrical wires to the assembly portion 72.

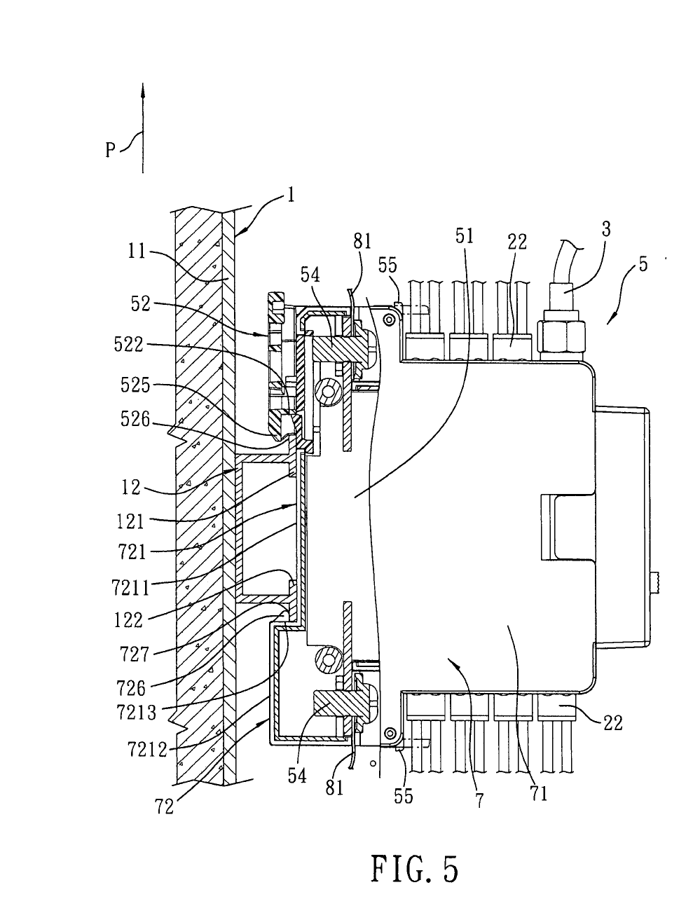

Each of the isolating tabs 55 can be swung to a non-isolating position as shown by the imaginary lines in FIG. 5 to allow a user to secure a corresponding one of the conductor components 54 to the assembly portion 72 using, for example, a screw driver. After the conductor components 54 are secured, the isolating tabs 55 can be swung to an isolating position as shown in FIG. 4, in order to provide isolation between a respective one of the conductor components 54 and the set of current measuring components 22 that is coupled to the set of connection ports 53. By virtue of the isolating tabs 55, a potential adverse effect attributed to undesirable electrical connection between the set of current measuring components 22 and the conductor components 54 may be avoided. The communication port 56 is disposed on an upper one of the connecting walls 711, on a side distal to the assembly portion 72.

The server 6 is operable to communicate with the wireless communication unit 3 wirelessly, and is operable to obtain the power consumption information therefrom for further processing. For example, the server 6 may be operable to calculate a total power consumption associated with the switches 13, and/or to calculate a monetary cost based on the power consumption information.

In embodiments, the server 6 may be embodied as a computer, cellphone, tablet, or any suitable electronic device that is provided with wireless communication, calculating and display capabilities.

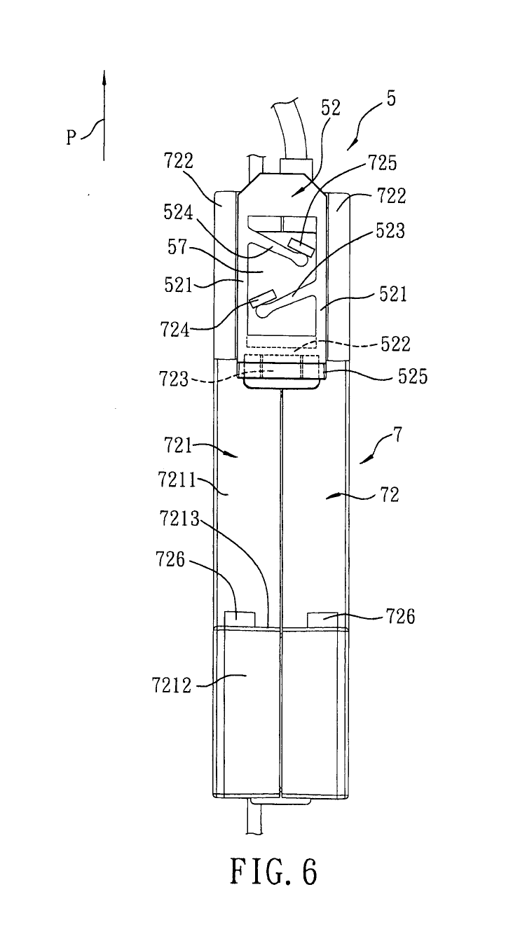

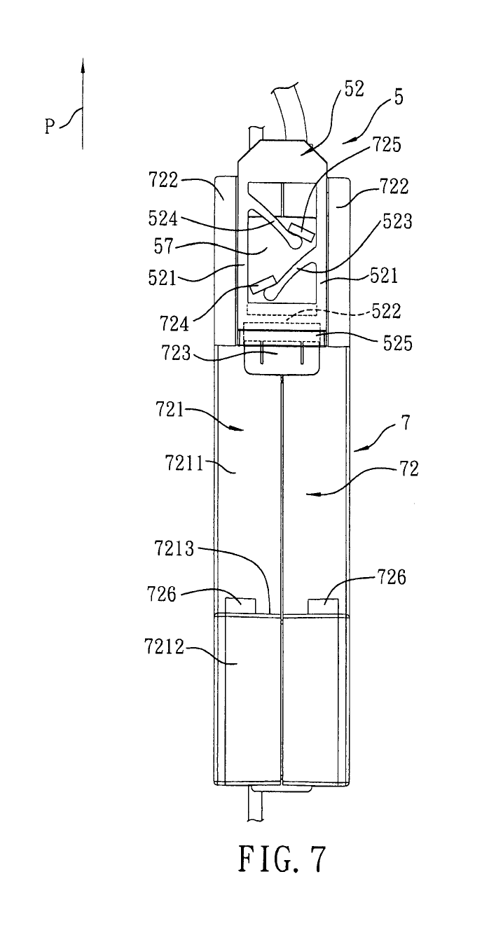

The track-engaging component 52 is movable relative to the shell body 7 between a locking position (see FIG. 6) and an unlocking position (see FIG. 7).

When the device 100 is secured on the slide track 12, the track-engaging component 52 is at the locking position, where the limiting wall 522 abuts against the first limiting block 723. As a result, the track-engaging component 52 is prohibited from moving along a direction opposite to the predetermined direction (P) with respect to the shell body 7. The first resilient tab 523 abuts against the second limiting block 724, thereby prohibiting the track-engaging component 52 from moving along the predetermined direction (P) with respect to the shell body 7. In addition, the second resilient tab 524 abuts against the third limiting block 725 for further prohibiting the track-engaging component 52 from moving along the predetermined direction (P) with respect to the shell body 7. The first track wall 121 and the second track wall 122 are slidably retained in the first track-receiving space 526 and the second track-receiving space 727 at this time.

As shown in FIG. 7, when it is desired to assemble/disassemble the device 100 and the slide track 12 of the electricity-consuming apparatus 1, the track-engaging component 52 is moved to the unlocking position, where the limiting wall 522 is spaced apart from the first limiting block 723. This can be done by the user exerting a force on the track-engaging component 52 along the predetermined direction (P) with respect to the shell body 7. In the unlocking position, the first track wall 121 is not received in the first track-receiving space 526, and the shell body 7 may be manipulated to remove the second track wall 122 from the second track-receiving space 727.

Accordingly, to assemble the device 100 to the slide track 12, the user may hold the track-engaging component 52 in the unlocking position, slide the second track wall 122 into the second track-receiving space 727, slide the first track wall 121 into the first track-receiving space 526, and release the track-engaging component 52 back to the locking position. On the other hand, to disassemble the device 100 from the slide track 12, the user may move the track-engaging component 52 to the unlocking position, move the track-engaging component 52 away from the slide track 12, and disengage the second track wall 122 from the second track-receiving space 727.

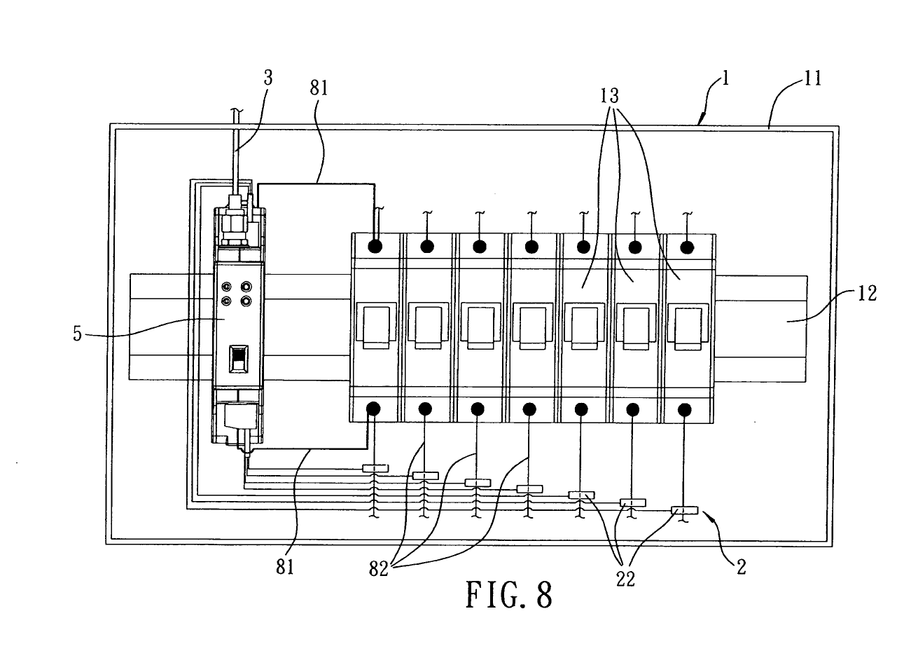

Referring to FIGS. 5 and 8, in operation, a pair of first electrical wires 81, which are respectively secured by the conductor components 54 to the assembly portion 72, are coupled across a selected one of the switches 53 (i.e., coupling the voltage measuring component 21 in parallel to the selected one of the switches 53) for obtaining a voltage across the selected one of the switches 53 (to serve as the voltage parameter). Additionally, the AC power is provided to the power supply unit 4 via the electrical wires 81 and the conductor components 54.

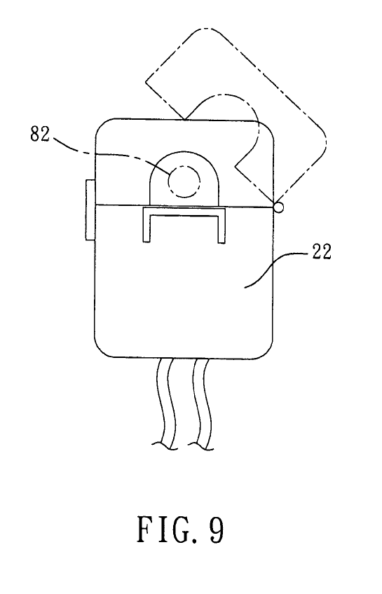

Referring to FIGS. 8 and 9, one of the current measuring components 22 is connected (such as by clamping) to one of a plurality of second electrical wires 82 that is coupled to a selected one of the switches 13 for obtaining a current flowing through the selected one of the switches 13 (to serve as the current parameter). Afterward, the voltage parameter and the set of the current parameters may be obtained and processed by the measuring unit 2 for obtaining the power consumption information.

To sum up, the configuration of the present invention enables the measuring unit 2 to obtain the set of current parameters associated with the set of switches 13 simultaneously. In addition, the wireless communication unit 3 is operable to transmit the power consumption information to the server 6. The device 100 of this invention has the capability to measure the current parameters of a plurality of electrical components, and to keep a remotely located user updated with the power consumption information.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A device for monitoring power consumption, said device to be coupled to an electricity-consuming apparatus and comprising:
a measuring unit including a set of current measuring components to be coupled to the electricity-consuming apparatus for obtaining a set of current parameters of the electricity-consuming apparatus, and a processor coupled to said set of current measuring components and operable to obtain power consumption information with reference to the set of current parameters obtained by said set of current measuring components;
a wireless communication unit coupled to said processor and operable to transmit the power consumption information; and
a shell unit including
a shell body that is disposed to receive said processor therein and that is formed with at least one opening, and
a set of connection ports disposed at said at least one opening and coupled to said processor;
wherein said set of current measuring components is coupled to said processor via said set of connection ports, and is exposed from said shell body.

2. The device of claim 1, further comprising a power supply unit coupled to said measuring unit and said wireless communication unit for providing power thereto.

3. The device of claim 1, the electricity-consuming apparatus including a housing, a slide track disposed in the housing, and a set of parallel coupled switches that is mounted on the slide track, wherein:
said shell unit further includes a track-engaging component that is configured to couple said shell body to the slide track and that is movable relative to said shell body along a predetermined direction.

4. The device of claim 3, wherein:
said shell body has an assembly portion that includes
a base wall that is disposed adjacent to the slide track,
a pair of spaced-apart outer assembly walls that protrude from said base wall toward the slide track, and that extend along the predetermined direction, and
a first limiting block and a second limiting block that protrude from said base wall toward the slide track, that are disposed between said outer assembly walls, and that are spaced apart from each other in the predetermined direction;
said track-engaging component is fitted between said outer assembly walls, and includes
a pair of spaced-apart inner assembly walls each disposed to face a respective one of said outer assembly walls,
a limiting wall that interconnects said inner assembly walls and that is disposed between said first limiting block and said second limiting block,
a space-defining wall that is spaced apart from and that cooperates with said base wall to define a first track-receiving space configured for sliding engagement with the slide track, and
a resilient tab that extends from one of said inner assembly walls toward the other one of said inner assembly walls, that is disposed between said limiting wall and said second limiting block, and that abuts against said second limiting block; and
said track-engaging component is movable relative to said shell body between a locking position, where said limiting wall abuts against said first limiting block, and an unlocking position, where said limiting wall is spaced apart from said first limiting block.

5. The device of claim 4, wherein said base wall has a stepped configuration and has a first surface that is provided with said first limiting block and said second limiting block and that extends in the predetermined direction, a second surface that is parallel to said first surface and that is configured to protrude toward the slide track relative to said first surface, and a third surface that extends between the first surface and the second surface,
said base wall further having a protruding block that is disposed on said third surface, that projects toward said first limiting block, and that is spaced apart from and that cooperates with said base wall to define a second track-receiving space configured for sliding engagement with the slide track.

6. The device of claim 4, wherein said shell unit further includes a communication port disposed on said shell body, and said wireless communication unit includes a radio frequency (RF) processor coupled to said processor and said communication port, and an antenna coupled to said communication port.

7. The device of claim 1, wherein said measuring unit further includes a voltage measuring component, said shell body is formed with two of said openings that are spaced apart from each other, and said shell unit further includes:
a pair of conductor components each disposed on said shell body adjacent to a respective one of said openings and each coupled to said voltage measuring component and to be coupled to the electricity-consuming apparatus; and
a pair of isolating tabs each disposed on said shell body and each configured to provide isolation between a respective one of said conductor components and said set of current measuring components.

8. The device of claim 7, wherein said isolating tabs are pivoted to said shell body.
